(19) United States
(12) Patent Application Publication
(10) Pub. No.: US 2026/0031885 A1
(43) Pub. Date: Jan. 29, 2026

(54) TERMINAL AND METHOD OF DETERMINING NARROW BEAM

(71) Applicant: SAMSUNG ELECTRONICS CO., LTD., SUWON-SI (KR)

(72) Inventors: DAHAE CHONG, SUWON-SI (KR); JINHONG KIM, SUWON-SI (KR); MYUNGJOON SHIM, SUWON-SI (KR); JUNHO LEE, SUWON-SI (KR); BEOMKON KIM, SUWON-SI (KR); JOOHYUN DO, SUWON-SI (KR); YOOJIN CHOI, SUWON-SI (KR)

(21) Appl. No.: 19/028,004

(22) Filed: Jan. 17, 2025

(30) Foreign Application Priority Data
Jul. 26, 2024 (KR) 10 2024 0099709

(51) Int. Cl. H04B 7/06; H04B 17/318; H04B 17/336; H04W 36/04

(52) U.S. Cl. CPC H04B 7/06952; H04B 17/328; H04B 17/336; H04W 36/04

(57) ABSTRACT

Provided are a terminal and method of determining a narrow beam. The method of determining a narrow beam includes sweeping a plurality of wide beams, calculating a plurality of wide beam measurement results respectively corresponding to the plurality of wide beams, calculating a reliability of the plurality of wide beam measurement results, and when the reliability of the plurality of wide beam measurement results is greater than a first threshold value, determining at least one narrow beam based on the plurality of wide beam measurement results without sweeping the at least one narrow beam.

### CROSS-REFERENCE

This application claims priority under 35 U.S.C. § 119 to Korean Patent Application No. 10-2024-0099709, filed on Jul. 26, 2024, in the Korean Intellectual Property Office, the disclosure of which is incorporated by reference herein in its entirety.

### FIELD

The inventive concept relates to a wireless communications terminal and method for determining a narrow beam of a reception beam pattern.

### INTRODUCTION

Beam-forming or spatial filtering is a signal processing technique used for directional signal transmission or reception. This may be achieved by configuring or combining antenna elements so that signals at particular angles experience constructive interference to form beams, while signals at other angles may experience destructive interference to form nulls. In a 3rd Generation Partnership Project (3GPP) new radio (NR) wireless communications system, a terminal may use an antenna having a relatively high beam-forming gain in order to compensate for power loss such as due to radio frequency band usage, and may continuously sweep a plurality of beams in order to secure an optimal beam. In an initial access, handover or handoff step, a relatively high time-delay may occur due to the time taken to sweep the plurality of beams if there are no applicable beam sweeping results yet available.

### SUMMARY

According to an embodiment, a method of determining a narrow beam is provided, including: sweeping a plurality of wide beams; calculating a plurality of wide beam measurement results respectively corresponding to the plurality of wide beams; calculating a reliability of the plurality of wide beam measurement results; and when the reliability of the plurality of wide beam measurement results is greater than a first threshold value, determining at least one narrow beam based on the plurality of wide beam measurement results without sweeping the at least one narrow beam.

According to an embodiment, a terminal is provided, including: a radio frequency (RF) circuit configured to sweep a plurality of wide beams; a processor configured to calculate a plurality of wide beam measurement results respectively corresponding to the plurality of wide beams, calculate a reliability of the plurality of wide beam measurement results; and a narrow beam module configured to determine at least one narrow beam based on the plurality of wide beam measurement results without sweeping the at least one narrow beam, when the reliability of the plurality of wide beam measurement results is greater than a first threshold value.

According to an embodiment, an electronic device is provided, including: a radio frequency (RF) circuit configured to sweep a plurality of wide beams; and a processor configured to calculate a plurality of wide beam measurement results respectively corresponding to the plurality of wide beams, determine at least one narrow beam and a reliability corresponding to each of the at least one narrow beam based on the plurality of wide beam measurement results without sweeping the at least one narrow beam, and when the reliability corresponding to each of the at least one narrow beam is less than or equal to a threshold value, update the plurality of wide beam measurement results

According to an embodiment, a method of determining a narrow beam is provided, including sweeping a plurality of wide beams, calculating a plurality of wide beam measurement results respectively corresponding to the plurality of wide beams, calculating reliability of the plurality of wide beam measurement results, and when the reliability of the plurality of wide beam measurement results is greater than a first threshold value, determining at least one narrow beam based on the plurality of wide beam measurement results by using an artificial intelligence (AI) module and/or algorithm.

According to an embodiment, a terminal is provided, including a radio frequency (RF) circuit configured to sweep a plurality of wide beams, and a processor configured to calculate a plurality of wide beam measurement results respectively corresponding to the plurality of wide beams, calculate reliability of the plurality of wide beam measurement results, and when the reliability of the plurality of wide beam measurement results is greater than a first threshold value, determine at least one narrow beam based on the plurality of wide beam measurement results by using an artificial intelligence (AI) module and/or algorithm.

According to an embodiment, a terminal is provided that includes a radio frequency (RF) circuit configured to sweep a plurality of wide beams, and a processor configured to calculate a plurality of wide beam measurement results respectively corresponding to the plurality of wide beams, determine at least one narrow beam and reliability corresponding to each of at least one narrow beam based on the plurality of wide beam measurement results by using an artificial intelligence (AI) module and/or algorithm, and when the reliability corresponding to each of the at least one narrow beam is less than or equal to a first threshold value, update the plurality of wide beam measurement results.

### BRIEF DESCRIPTION OF THE DRAWINGS

Embodiments will be more clearly understood from the following detailed description when taken in conjunction with the accompanying drawings in which:

FIG. 1 is a block diagram of a terminal according to an embodiment;

FIG. 2 is a polar diagram showing a reception beam pattern of a terminal according to an embodiment;

FIG. 3 is a block diagram showing an artificial intelligence (AI) module according to an embodiment;

FIG. 4 is a tabular diagram showing a table including an index of a narrow beam and a cell identification (ID) corresponding to the narrow beam according to an embodiment;

FIG. 5 is a flowchart diagram illustrating a method of determining a narrow beam, according to an embodiment;

FIG. 6 is a flowchart diagram illustrating a method of determining a narrow beam, according to an embodiment;

FIG. 7 is a flowchart diagram illustrating a method of determining a narrow beam, according to an embodiment;

FIG. 8 is a flowchart diagram illustrating a method of determining a narrow beam, according to an embodiment; and

FIG. 9 is a block diagram of a terminal according to an embodiment.

### DETAILED DESCRIPTION

A base station (BS) is an apparatus for communicating with a terminal and allotting communications network resources to the terminal. For example, the base station may be at least one of a cell, a NodeB (NB), an eNodeB (eNB), a next generation radio access network (NG RAN), a wireless access unit, a BS controller, a node on a network, a gNodeB (gNB), a transmission and reception point (TRP), and/or a remote radio head (RRH).

A terminal is an apparatus capable of communicating with a BS or another terminal. For example, the terminal may be at least one of a node, user equipment (UE), next generation UE (NG UE), a mobile station (MS), mobile equipment (ME), and/or an electronic device.

The terminal may include at least one of a smartphone, a tablet computer, a personal computer (PC), a mobile phone, a video phone, an e-book reader, a desktop PC, a laptop PC, a netbook computer, a Personal Digital Assistant (PDA), a portable Multimedia Player (PMP), an MP3 player, a medical device, a camera, and/or a wearable device. The terminal may also include at least one of a television (TV), a Digital Video Disk (DVD) player, an audio player, a refrigerator, an air conditioner, a cleaner, an oven, a microwave oven, a washing machine, an air cleaner, a set-top box, a home automation control panel, a security control panel, a media box (e.g., Samsung HomeSync™, Apple TV™, Google TV™, etc.), a game console (e.g., Xbox™, PlayStation™, etc.), an electronic dictionary, an electronic key, a camcorder, and/or an electronic frame. The terminal may also include at least one of a medical device such as a stationary or portable medical measuring devices including a glucometer, a heart rate monitor, a blood pressure monitor, and/or a body temperature thermometer, a Magnetic Resonance Angiography (MRA) device, a Magnetic Resonance Imaging (MRI) device, a Computed Tomography (CT) device, a camcorder, a microwave scanner, a navigation device, a Global Navigation Satellite System (GNSS), an Event Data Recorder (EDR), a Flight Data Recorder (FDR), an automotive infotainment device, marine electronic equipment such as a marine navigation system and/or a gyro compass, aviation electronics or avionics, security equipment, an automotive head unit, an industrial or household robot, a drone, an Automated Teller Machine (ATM), a Point Of Sale (POS) terminal, and/or an Internet-of-Things (IoT) device such as an electric bulb, a sensor, a sprinkler system, a fire alarm system, a temperature controller, a street lamp, a toaster, fitness equipment, a hot water tank, a heater, and/or a boiler, or the like. The terminal may further include various types of multimedia systems having a communications function.

For example, a wireless communications terminal operating over a radio frequency band, such as a millimeter wavelength band, may use an antenna with a relatively high beam-forming gain to overcome various signal propagation losses. The terminal may execute a full-circle angular beam sweep to acquire an optimal beam between a base station and the terminal, and may repeat the full-circle beam sweep either periodically or more frequently as the signal propagation environment changes. However, each full-circle beam sweep takes a finite amount of time and energy.

If the signal propagation environment changes rapidly due to movement of the terminal itself, movement of an intermediate signal reflector such as a large metal truck, or changes in a signal transmission medium such as local weather events, the full-circle beam sweeps can take significant amounts of time and energy to identify suitable narrow beam characteristics based on one or more signal quality indicators, particularly in low signal reception areas.

In an embodiment, an initial full-circle segmented angular beam sweep, or wide beam sweep, may be performed, optionally with reduced resolution or larger angular increments to save time and/or power, and only those segments or wide beams of the initial sweep having relatively better signal quality results may be further swept, optionally with increased resolution and/or more frequently, or optionally processed without further sweeping, to detect narrow beams. So the time and/or energy consumed to determine or secure a narrow beam by sweeping may be minimized.

Moreover, after completion of the initial wide beam sweep, some apparently wide beams or segments having stronger results need not be further swept for narrow beams, but may instead be searched or further processed for the narrow beams without further sweeps based on heuristics, machine-learning and/or artificial intelligence algorithms to predict or secure narrow beams based on selected segments of the initial wide beam sweep results.

If a secured narrow beam is used after completing a segmented wide beam search, searching for a next beam of high probability may be accelerated based on a previous search result, such as a very recent search result, a search result from substantially the same location and/or a search result obtained under substantially the same signal propagation conditions.

Multiple wide beam sweeps may be made, their reliabilities assessed, and only those of relatively higher reliability might be further swept and/or processed to secure a narrow beam. For example, the reliability of each wide beam sweep result may be determined before performing an operation using an artificial intelligence (AI) module to economically generate a narrow beam result with high reliability. Moreover, a narrow beam determined by the AI module may be selected and/or stored based on this reliability.

A cellular telecommunications network uses a wireless link to and from end nodes or terminals, where the network is distributed over land areas called cells that are served by at least one fixed-location transceiver. A cellular handover or handoff is the process of transferring an ongoing call or data session from one core network channel or cell to another channel or cell without loss or interruption. Similarly in satellite communications, the handover or handoff is the process of transferring satellite control responsibility from one earth station to another without loss or interruption.

In an embodiment, when initially accessing a cell or station, wide beams are swept and a narrow beam may be determined based on the wide beam measurement results, such as by providing the wide beam measurement results to the AI module pr algorithm without further sweeping, to determine a narrow beam. For example, when a cellular and/or satellite communications handover or handoff event occurs, the narrow beam may be determined with reference to a stored table without sweeping the wide beams.

Hereinafter, one or more embodiments of the inventive concept will be described in greater detail with reference to the accompanying drawings.

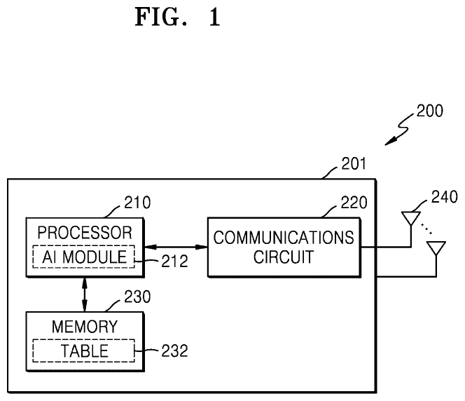

FIG. 1 shows a wireless communications terminal system, generally indicated by the reference numeral 200, according to an embodiment.

Referring to FIG. 1, the wireless communications terminal system 200 may include a wireless communications terminal device 201, a processor 210, a communications circuit 220, such as a radio frequency (RF) integrated circuit (RFIC), connected to the processor, a memory 230 connected to the processor, and a plurality of antennas 240 connected to the communications circuit 220. The antennas 240 may include an active antenna and/or a passive antenna, and may be included within the terminal device 201 and/or may be externally connected to the device.

The processor 210 may control the communications circuit 220, and may be configured to implement an operating method of the terminal system 200 and operating flowcharts according to the inventive concept. The terminal system 200 may include the plurality of antennas 240, and the communications circuit 220 may transmit/receive wireless signals via one or more antennas 240. At least some of the plurality of antennas 240 may correspond to transmission antennas. A transmission antenna may transmit a wireless signal to an external device (e.g., another user equipment UE, base station BS, or the like) terminal system 200. At least one of the remaining antennas 240 may correspond to reception antennas. The reception antenna may receive a wireless signal from the external device. According to an embodiment, the reception antenna may include an antenna having a relatively high beam-forming gain and may be used to sweep the beam.

The processor 210 may control the communications circuit 220 to sweep a plurality of wide beams. The processor 210 may calculate a wide beam measurement result corresponding to each of the plurality of wide beams and reliability of the plurality of wide beam measurement results. For example, in an initial stage in which the terminal system 200 is turned on and is connected to a cell, after turning on the terminal system 200 and before tuning for stabilized operations is finished, the plurality of wide beam measurement results may be relatively unreliable, such as incomplete or inaccurate. When determining the narrow beam based on the plurality of wide beam measurement results that are relatively unreliable, an inappropriate narrow beam may be determined. Accordingly, the terminal system 200 may determine whether to use the wide beam measurement results for determination of the narrow beam based on reliability of the plurality of wide beam measurement results. In greater detail, in order to determine the narrow beam accurately, a restriction may be set so that a plurality of wide beam measurement results having a variation greater than a threshold value are preferentially used. Because it is more likely to successfully determine an accurate narrow beam by using the plurality of wide beam measurement results having a variation greater than the threshold value, it may be understood that the plurality of wide beam measurement results, having a variation greater than the threshold value, has relatively high reliability. Conversely, it is less likely to determine an accurate narrow beam by using a plurality of wide beam measurement results having a variation less than or equal to the threshold value, so it may be understood that such a plurality of wide beam measurement results has relatively low reliability.

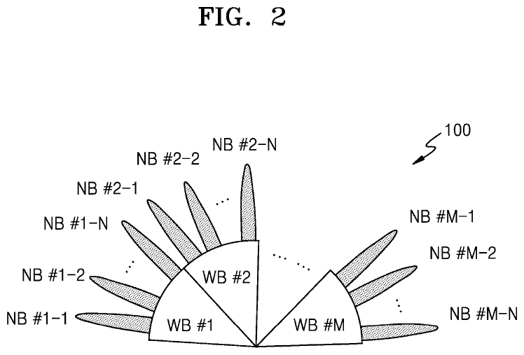

FIG. 2 shows a reception beam pattern, generally indicated by the reference numeral 100, of a wireless communications terminal system according to an embodiment. Hereinafter, for convenience of understanding the reception beam pattern 100 of FIG. 2, reference is made back to some elements of FIG. 1.

Referring to FIG. 2, the terminal system 200 of FIG. 1 may sweep up to M wide beams WB #1 through WB #M via the communications circuit 220. The M wide beams WB #1 through WB #M may each include up to N corresponding narrow beams NB #1-1 through NB #1-N, NB #2-1 through NB #2-N, . . . , NB #M−1 through NB #M−N. For example, a wide beam WB #1 may include N narrow beams NB #1-1 through NB #1-N.

After sweeping the M wide beams WB #1-WB #M by using the communications circuit 220, the processor 210 may calculate a plurality of wide beam measurement results corresponding respectively to the M wide beams WB #1 through WB #M. The wide beam measurement results with respect to wide beams WB #1 through WB #M may include at least one of reference signal received power (RSRP), reference signal received quality (RSRQ), received signal strength indicator (RSSI), and/or signal-to-interference-plus-noise ratio (SINR) of the wide beams WB #1 through WB #M.

The processor 210 may determine a wide beam of the M wide beams having the strongest wide beam measurement result, based on the plurality of wide beam measurement results. For example, the processor 210 may determine a wide beam having the largest RSRP. The processor 210 may calculate a plurality of narrow beam measurement results for narrow beams corresponding to the wide beam having the strongest wide beam measurement result after a transition period has elapsed or an automatic gain control (AGC) has stabilized. Here, the AGC denotes that an output level is controlled to maintain a relatively consistent value even when an input level fluctuates in an amplifier of a terminal. The narrow beam measurement result may include at least one of RSRP, RSRQ, RSSI, and/or SINR of the narrow beam. Here, for example, a transition period may denote 5, 10, 20, 40, 80 or 160 milliseconds (ms), without limitation thereto.

In this illustrative example, the processor 210 calculates the narrow beam measurement result after a transition period has elapsed or the AGC has stabilized, but it shall be understood that the inventive concept is not limited thereto. For example, the processor 210 may calculate the narrow beam measurement result immediately after determining the wide beam having the strongest wide beam measurement result.

The processor 210 may determine the narrow beam having the strongest narrow beam measurement result by using the calculated narrow beam measurement results. For example, the processor 210 may determine a narrow beam having the largest RSRP. An example in which the processor 210 determines the narrow beam having the largest RSRP is described above, but the inventive concept is not limited thereto. For example, the processor 210 may determine x narrow beams having the relatively strongest narrow beam results. Here, x may be 2 or a greater integer. In addition, the processor 210 may store an index of each of the relatively strongest x narrow beams and a cell identification (ID) corresponding to the relatively strongest x narrow beams in the memory 230, such as in a table but without limitation thereto.

When the narrow beam is determined in the above manner, at least (M+N) synchronization signal block (SSB) periods may be consumed. Hereinafter, the above method is referred to as an M+N sweeping method. In the initial accessing step or handover step requiring rapid cell access, a large amount of delay may occur in the M+N sweeping method due to the (M+N) SSB periods.

Referring back to FIG. 1, an artificial intelligence (AI) module and/or algorithm 212 may be built into and/or otherwise be in signal communication with the processor 210. In an embodiment, the AI module and/or algorithm 212 is built into the processor 210 as an example, but the inventive concept is not limited thereto. For example, an AI module installed outside the terminal system 200 may be used, or the terminal system 200 may communicate with the AI module installed outside the terminal device 201 through a network. Data, algorithms and/or operation models to be used for the AI module to perform the operation may be stored in the memory 230.

In an embodiment, the AI module, data, algorithms and/or operation models may be implemented in a real-time AI platform, an operational real-time data store, and/or a digital operating model such as in a machine-learning (ML) AI. The AI module or algorithm may have deterministic outputs, and/or non-deterministic outputs such as generative AI.

According to an embodiment, the AI module and/or algorithm may include at least one of a multilayer perceptron (MLP), a convolutional neural network (CNN), a recurrent neural network (RNN), a transformer, a long short-term memory (LSTM) structure, or the like.

In an embodiment, the processor 210 may compare reliability of the calculated plurality of wide beam measurement results with a first threshold value. For example, the reliability of the plurality of wide beam measurement results may be related to a variation within the plurality of wide beam measurement results. For example, the reliability of the plurality of wide beam measurement results may be related to a variation of an upper measurement result from among the plurality of wide beam measurement results. In another example, the reliability of the plurality of wide beam measurement results may be calculated by using the AI module and/or algorithm, such as based on prior results, machine-learning, and/or training data outcomes.

When the reliability of the plurality of wide beam measurement results is greater than the first threshold value, the processor 210 may determine at least one narrow beam based on the plurality of wide beam measurement results by using the AI module and/or algorithm.

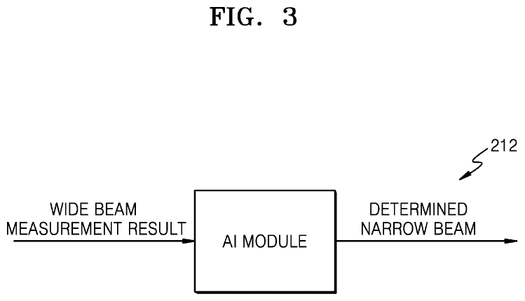

FIG. 3 shows an AI module and/or algorithm, generally indicated by the reference numeral 212, according to an embodiment.

Referring to FIG. 3, the AI module and/or algorithm 212 may receive the plurality of wide beam measurement results and select or determine at least one narrow beam. For example, the AI module and/or algorithm 212 may output at least one determined narrow beam and a reliability R corresponding to each of the at least one determined narrow beam, as a result.

The plurality of wide beam measurement results may include at least one of RSRP, RSRQ, RSSI, and/or SINR of the plurality of wide beams, without limitation thereto. For example, the plurality of wide beam measurement results may additionally or alternately include at least one of rank indicator (RI), block error rate (BLER), and channel quality indicator (CQI). The plurality of wide beam measurement results may be input to the AI module and/or algorithm in the form of a vector, without limitation thereto.

The aforementioned indicators used as the wide beam measurement results are examples, and the inventive concept is not limited thereto. For example, a precoding matrix indicator (PMI) may be input to the AI module and/or algorithm as a wide beam measurement result.

The respective reliability R corresponding to each of the at least one narrow beam may be different from the reliability of the plurality of wide beam measurement results. The reliability R corresponding to each of the at least one narrow beam may be an indicator indicating an accuracy of the operation result from the AI module and/or algorithm and may be expressed in a percentage, without limitation thereto. The reliability of the plurality of wide beam measurement results may be related to a variation within the plurality of wide beam measurement results. For example, the reliability of the plurality of wide beam measurement results may be related to a variation in an upper measurement result from among the plurality of wide beam measurement results. In another example, the reliability of the plurality of wide beam measurement results may be calculated by using the AI module and/or algorithm, such as based on prior results, machine-learning, and/or training data outcomes.

The reliability of the plurality of wide beam measurement results may be an indicator representing the probability of outputting an accurate result when the plurality of wide beam measurement results are input to the AI module and/or algorithm. For example, when all wide beams within the plurality of wide beam measurement results have very high SINR, that is, the variation between them is close to 0, the input wide beam measurement results are not reliably discriminating, and the probability that the output results from the AI module and/or algorithm are accurate may be relatively low.

Referring back to FIG. 1, the processor 210 determines the reliability of the wide beam measurement results before performing the operation by using the AI module and/or algorithm, and thus, generation of operation results with relatively low reliability may be prevented, and channel acquisition time and/or power consumption may be reduced.

When the reliability of the plurality of wide beam measurement results is greater than the first threshold value, the processor 210 may determine at least one narrow beam based on the plurality of wide beam measurement results by using the AI module and/or algorithm. The first threshold value may be a value set according to the wide beam measurement results, without limitation thereto. For example, the first threshold value may have a value of 0.1, 1, 2, or the like.

According to an embodiment, when the reliability of the plurality of wide beam measurement results is less than or equal to the first threshold value, the processor 210 may update the plurality of wide beam measurement results via the communications circuit 220. For example, when the reliability of the plurality of wide beam measurement results is less than or equal to the first threshold value, the processor 210 may update the plurality of wide beam measurement results by measuring the plurality of wide beams via the communications circuit 220 after a transition period of time has elapsed since the plurality of wide beam measurement results were obtained or the AGC was stabilized. For example, the transition period of time may denote 5, 10, 20, 40, 80 or 160 ms, without limitation thereto.

The updated plurality of wide beam measurement results may include the same kinds of indicators as those of the plurality of wide beam measurement results obtained before the update, or may include additional or different kinds of indicators from those of the plurality of wide beam measurement results obtained before the update. For example, the plurality of wide beam measurement results obtained before the update may be related to the RSRP, and the updated plurality of wide beam measurement results may be related to the SINR.

In another example, the updated plurality of wide beam measurement results may include more measurement results and/or additional types of measurement results. For example, the plurality of wide beam measurement results before the update may be related to the RSRP, and the updated plurality of wide beam measurement results may be related to both the RSRP and the SINR.

According to an embodiment, the processor 210 may calculate the reliability of the updated plurality of wide beam measurement results, and may compare the reliability of the updated plurality of wide beam measurement results with a second threshold value. The second threshold value may be greater than or equal to the first threshold value. When the reliability of the updated plurality of wide beam measurement results is greater than the second threshold value, the processor 210 may determine at least one narrow beam based on the updated plurality of wide beam measurement results by using the AI module and/or algorithm.

According to an embodiment, when the reliability of the updated plurality of wide beam measurement results is less than or equal to the second threshold value, the processor 210 may determine one narrow beam by using the M+N sweeping method. Although the M+N sweeping method may be executed when the reliability of the updated plurality of wide beam measurement results is less than or equal to the second threshold value, the inventive concept is not limited thereto. For example, when the reliability of the plurality of wide beam measurement results is less than or equal to the first threshold value, the M+N sweeping method may be executed without even updating the plurality of wide beam measurement results, to determine one narrow beam.

The processor 210 may control the memory 230 to store the indices of at least one narrow beam and the cell IDs corresponding to the at least one narrow beam. For example, a narrow beam having a wide beam index of m (from the 1-M wide beams) and a narrow beam index of n (from the 1-N narrow beams) may be indexed as beam number (m, n). The processor 210 may select the narrow beam from among the at least one narrow beam, and access the cell corresponding to the selected narrow beam by using the selected narrow beam to perform physical broadcast channel (PBCH) decoding, without limitation thereto.

In an embodiment, when the terminal system 200 initially accesses the cell, only the wide beams may be swept and the narrow beam may be determined based on the swept wide beams by using the AI module and/or algorithm, unlike the method of sweeping the wide beam and the narrow beam, and thus, the time taken to access the cell may be reduced.

According to an embodiment, from among the determined at least one narrow beam, the index of the narrow beam having the reliability R that is greater than a third threshold value and the cell ID corresponding to the narrow beam may be stored. For example, the processor 210 may select the narrow beam having a reliability R of 90% or greater from among the determined at least one narrow beam, and may control the memory 230 to store the index of the selected narrow beam and the cell ID corresponding to the selected narrow beam. For example, the index of the selected narrow beam and the cell ID corresponding to the selected narrow beam may be stored in a table.

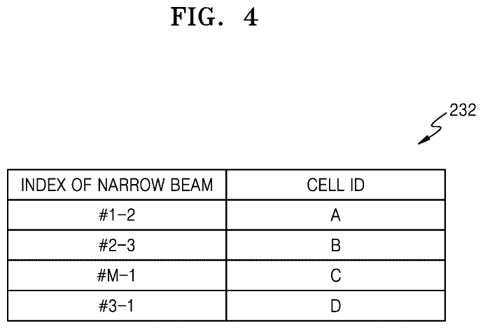

FIG. 4 shows a table, generally indicated by the reference numeral 232, including an index of a narrow beam and a cell ID corresponding to the narrow beam.

Referring to FIG. 4, the index and the cell ID of at least one relatively high R narrow beam may be stored in the table in one-to-one correspondence. Reference signs A-D may denote cell IDs. The terminal system 200 may execute post operations with reference to the stored table.

Referring back to FIG. 1, when a handover event occurs, the processor 210 determines the narrow beam index stored in the memory 230, based on the cell ID of a handover target cell, and may perform the handover with the handover target cell by using the narrow beam corresponding to the determined narrow beam index.

After the handover event has occurred, the narrow beam may be determined with reference to the table stored in the memory 230, without sweeping the narrow beam corresponding to the handover target cell, and thus, the delay may be reduced by at least as much as the narrow beam sweeping time.

According to an embodiment, if the reliability R of the determined at least one narrow beam is less than or equal to the third threshold value, the processor 210 may update the plurality of wide beam measurement results. Next, when the reliability of the updated plurality of wide beam measurement results is less than or equal to the second threshold value, the processor 210 may execute the M+N sweeping method.

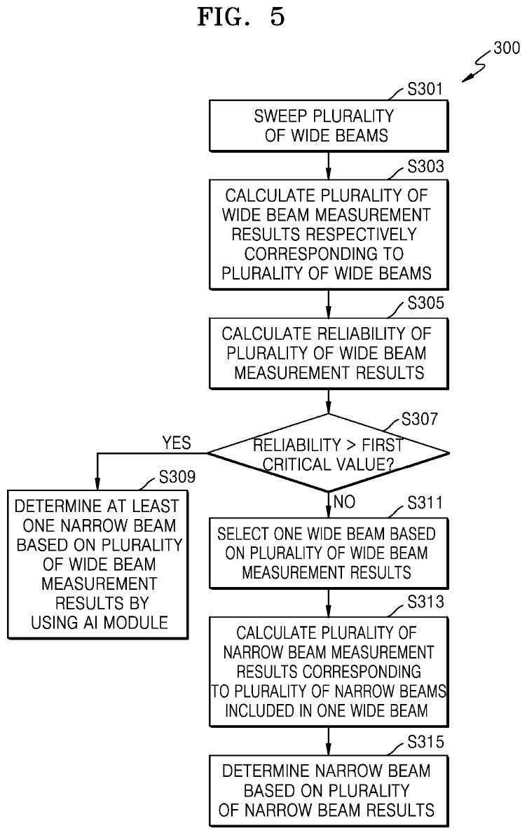

FIG. 5 shows a method, generally indicated by the reference numeral 300, of determining a narrow beam according to an embodiment.

Referring to FIG. 5, in operation S301, the terminal system 200 may sweep a plurality of wide beams. Next, in operation S303, the terminal system 200 may calculate a plurality of wide beam measurement results respectively corresponding to the plurality of wide beams. The plurality of wide beam measurement results may include at least one of RSRP, RSRQ, RSS, and SINR of the plurality of wide beams. Otherwise or additionally, the plurality of wide beam measurement results may further include at least one of RI, BLER, and CQI.

In operation S305, the terminal system 200 may calculate the reliability of the plurality of wide beam measurement results. The reliability of the plurality of wide beam measurement results may be related to a variation within the plurality of wide beam measurement results. For example, the reliability of the plurality of wide beam measurement results may be related to a variation of upper measurement results from among the plurality of wide beam measurement results. In another example, the reliability of the plurality of wide beam measurement results may be calculated by using the AI module and/or algorithm 212.

In operation S307, the terminal system 200 may compare the reliability of the plurality of wide beam measurement results with the first threshold value. The first threshold value may be a value set according to the wide beam measurement results. For example, the first threshold value may have a value of 0.1, 1, 2, or the like.

When the reliability of the plurality of wide beam measurement results is greater than the first threshold value, in operation S309, the terminal system 200 may determine at least one narrow beam based on the plurality of wide beam measurement results by using the AI module and/or algorithm. For example, the plurality of wide beam measurement results may be input to the AI module and/or algorithm in the form of a vector.

When the reliability of the plurality of wide beam measurement results is less than or equal to the first threshold value, in operation S311, the terminal system 200 may select the wide beam based on the plurality of wide beam measurement results. Next, in operation S311, the terminal system 200 may calculate a plurality of narrow beam measurement results corresponding to a plurality of narrow beams included in the selected wide beam.

For example, referring to FIG. 2, a wide beam WB #2 may be selected, and the measurement results of the plurality of narrow beams NB #2-1 through NB #2-N may be calculated. Similarly to the wide beam measurement results, the narrow beam measurement result may include at least one of the RSRP, RSRQ, RSS, and SINR of the narrow beam.

In operation S315, the terminal system 200 may determine the narrow beam based on the plurality of narrow beam measurement results. For example, from among the plurality of narrow beam measurement results, the narrow beam having the largest RSRP may be determined.

Additionally, the terminal system 200 may store the index of at least one narrow beam determined in operation S309 and the cell ID corresponding to the at least one narrow beam. For example, the terminal system 200 may store the index of the determined narrow beam and the cell ID corresponding to the determined narrow beam in the form of the table.

For example, the terminal system 200 may select the narrow beam from among the at least one narrow beam determined in operation S309, access the cell corresponding to the selected narrow beam by using the selected narrow beam, and perform PBCH decoding.

In another example, when a handover event occurs, the terminal system 200 determines the index of the stored narrow beam based on the cell ID of the handover target cell, and may perform the handover with the handover target cell by using the narrow beam corresponding to the determined index.

In an embodiment of the terminal system 200 that determines the reliability of the wide beam measurement results first, before performing the operation using the AI module and/or algorithm, generation of the operation results with relatively low reliability may be prevented and power consumption may be reduced. When the terminal system 200 initially accesses the cell, the terminal system 200 may determine the narrow beam based on the wide beam measurement results by using the AI module and/or algorithm after sweeping the wide beam, without sweeping the wide beams and the narrow beams, and thus, the delay may be reduced. In particular, when the hand-over event occurs, the terminal system 200 may determine the narrow beam with reference to the stored table, without sweeping the wide beams, and the delay may be further reduced.

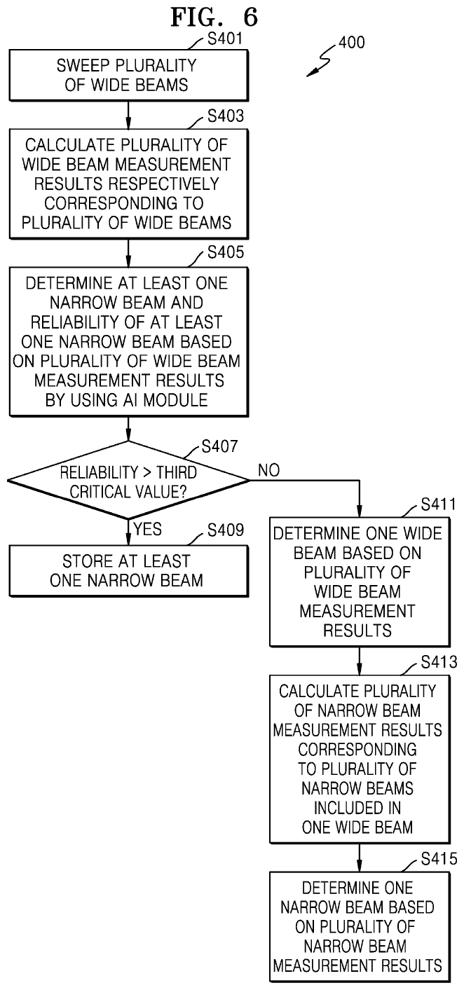

FIG. 6 shows a method, generally indicated by the reference numeral 400, of determining a narrow beam according to an embodiment.

Referring to FIG. 6, operation S401, operation S403, and operations S411-S415 are substantially the same as operation S301, operation S303, and operations S311-S315 in FIG. 5, respectively, and thus substantially duplicate descriptions thereof may be omitted.

In operation S405, the terminal system 200 may determine at least one narrow beam and the reliability R of the at least one narrow beam based on the plurality of wide beam measurement results by using the AI module and/or algorithm. The reliability R corresponding to each of the at least one narrow beam may be an indicator indicating an accuracy of the operation result from the AI module and/or algorithm and may be expressed as a percentage, without limitation thereto.

Next, in operation S407, the terminal system 200 may compare the reliability R of the determined at least one narrow beam with the third threshold value. When the reliability R of the determined at least one narrow beam is greater than the third threshold value, in operation S409, the terminal system 200 may store the index of the narrow beam and the cell ID corresponding to the narrow beam. For example, the terminal system 200 may select, from among the determined at least one narrow beam, a narrow beam having a reliability R of 90% or greater, and may store the index of the selected narrow beam and the cell ID corresponding to the selected narrow beam in the table 232.

When the reliability R of the determined at least one narrow beam is less than or equal to the third threshold value, the terminal system 200 may execute operations S411 through S415.

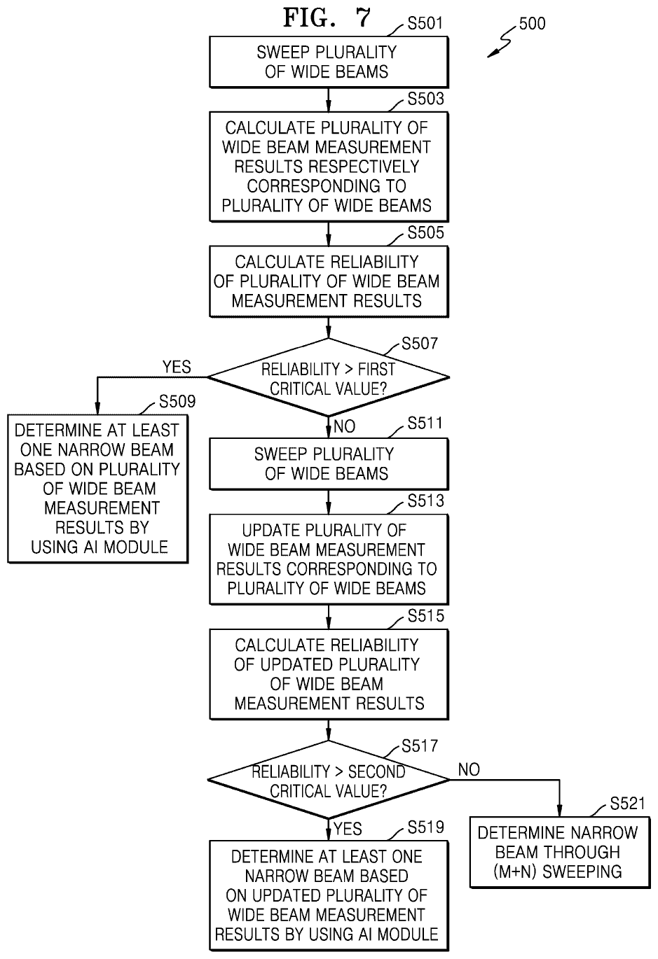

FIG. 7 shows a method, generally indicated by the reference numeral 500, of determining a narrow beam according to an embodiment.

Referring to FIG. 7, operation S501 through operation S509 are substantially the same as operation S301 through operation S309 in FIG. 5, respectively, and thus substantially duplicate descriptions thereof may be omitted. Operation S521 is substantially the same as operations S417 through S421 in FIG. 6, and is shown as one operation in FIG. 7 for clarity.

In this embodiment, when the reliability of the plurality of wide beam measurement results is less than or equal to the first threshold value after operation S507, the terminal system 200 may sweep the plurality of wide beams in operation S511. In operation S513, the terminal system 200 may update the plurality of wide beam measurement results. In greater detail, after a transition period has elapsed or the AGC has stabilized, the terminal system 200 may sweep the plurality of wide beams and measure the plurality of wide beams to update the plurality of wide beam measurement results. For example, the transition period may be 5, 10, 20, 40, 80 or 160 ms, without limitation thereto.

In operation S515, the terminal system 200 calculates the reliability of the updated plurality of wide beam measurement results, and in operation S517, the terminal system 200 may compare the reliability of the updated plurality of wide beam measurement results with the second threshold value.

When the reliability of the updated plurality of wide beam measurement results is greater than the second threshold value, in operation S519, the terminal system 200 may determine at least one narrow beam based on the updated plurality of wide beam measurement results by using the AI module and/or algorithm.

When the reliability of the updated plurality of wide beam measurement results is less than or equal to the second threshold value, the terminal system 200 may perform operation S521 to determine the narrow beam through (M+N) sweeping.

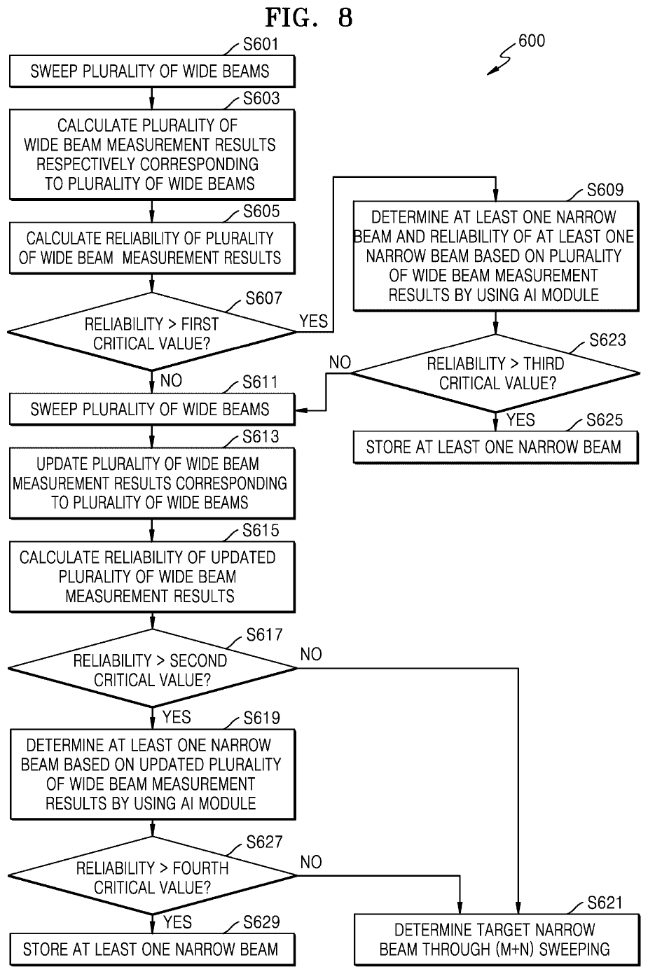

FIG. 8 shows a method, generally indicated by the reference numeral 600, of determining a narrow beam according to an embodiment.

Referring to FIG. 8, operation S601 through operation S621 are substantially the same as operation S501 through operation S521 in FIG. 7, respectively, and thus substantially duplicate descriptions thereof may be omitted.

After operation S609 in operation S623, the terminal system 200 may compare the reliability R of the determined at least one narrow beam with the third threshold value. When the reliability R of the determined at least one narrow beam is greater than the third threshold value, in operation S625, the terminal system 200 may store the index of the narrow beam and the cell ID corresponding to the narrow beam, such as in the table 232. For example, when the third threshold value is 89%, the terminal system 200 may select, from among the determined at least one narrow beam, a narrow beam having a reliability R of 90% or greater, and may store the index of the selected narrow beam and the cell ID corresponding to the selected narrow beam in the table 232, without limitation thereto.

When the reliability R of the determined at least one narrow beam is less than or equal to the third threshold value, the terminal system 200 may execute operation S611.

Similarly, after operation S619, the terminal system 200 may compare the reliability R of the determined at least one narrow beam with a fourth threshold value in operation S627. The fourth threshold value may be greater than or equal to the third threshold value. For example, the fourth threshold value may be 94%.

When the reliability R of the determined at least one narrow beam is greater than the fourth threshold value, in operation S629, the terminal system 200 may store the index of the narrow beam and the cell ID corresponding to the narrow beam. For example, the terminal system 200 may select, from among the determined at least one narrow beam, a narrow beam having a reliability R of 95% or greater, and then, may store the index of the selected narrow beam and the cell ID corresponding to the selected narrow beam in the table.

When the reliability R of the determined at least one narrow beam is less than or equal to the third threshold value, the terminal system 200 may execute operation S611.

When the reliability R of the determined at least one narrow beam is less than or equal to the fourth threshold value, the terminal system 200 may execute operation S621 to determine the target narrow beam through (M+N) sweeping.

The terminal system 200 selects the narrow beam from among the at least one narrow beam determined in operation S609 or operation S619, and accesses the cell corresponding to the selected narrow beam by using the selected narrow beam and performs PBCH decoding.

In another example, when a handover event occurs, the terminal system 200 determines the index of the stored narrow beam in operation S625 or operation S629 based on the cell ID of the handover target cell, and may perform the handover with the handover target cell by using the narrow beam corresponding to the determined index.

Because the terminal system 200 determines the reliability of the wide beam measurement results first, before performing the operation using the AI module and/or algorithm, generation of the operation results with relatively low reliability may be prevented and power consumption may be reduced.

When the terminal system 200 initially accesses the cell, the terminal system 200 may determine the narrow beam based on the wide beam measurement results by using the AI module and/or algorithm after sweeping the wide beams, without then sweeping the wide beams and the narrow beams, and thus, the delay may be reduced.

In particular, when the handover event occurs, the terminal system 200 may determine the narrow beam with reference to the stored table, without sweeping the wide beam, and the delay may be further reduced. By selecting and storing at least one narrow beam based on the operation results from the AI module and/or algorithm considering the reliability R, performance of the terminal system 200 may be optimized.

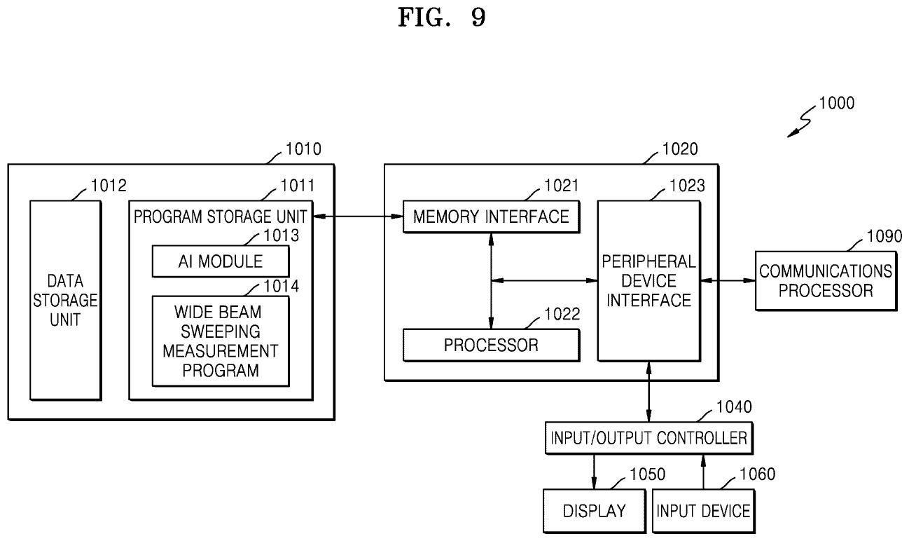

FIG. 9 shows an electronic terminal device, generally indicated by the reference numeral 1000, according to an embodiment. The electronic terminal device 1000 may correspond to the terminal device 201 of FIG. 1, without limitation thereto.

Referring to FIG. 9, the electronic terminal device 1000 may include a memory 1010, a processor unit 1020 connected to the memory, an input/output controller 1040 connected to the processor unit, a display 1050 connected to the input/output controller, an input device 1060 connected to the input/output controller, and a communications processor 1090 connected to the processor unit. Here, a plurality of memories 1010 may be provided.

The memory 1010 may include a program storage unit 1011 which stores a program for controlling operations of the electronic terminal device 1000, and a data storage unit 1012 which stores data generated during execution of the program. The data storage unit 1012 may store data that is required in the operations of an AI module and/or algorithm 1013 and a wide beam sweeping measurement program 1014. The program storage unit 1011 may include the AI module and/or algorithm 1013 and the wide beam sweeping measurement program 1014. Here, the program included in the program storage unit 1011 is a group of instructions and may be referred to as an instruction set.

The wide beam sweeping measurement program 1014 may sweep a plurality of wide beams according to embodiments, calculates a plurality of wide beam measurement results, and calculates reliability of the calculated measurement results. According to an embodiment, the AI module and/or algorithm 1013 may receive the results from the wide beam sweeping measurement program 1014 and determine at least one narrow beam.

A peripheral device interface 1023 may control connections between input/output peripheral devices of a base station, and the processor 1022 and a memory interface 1021. The processor 1022 may control the base station to provide corresponding service by using at least one software program. Here, the processor 1022 may execute at least one program stored in the memory 1010 and may provide the service corresponding to the program.

The input/output controller 1040 may provide an interface between the input/output device such as the display 1050 and the input device 1060, and the peripheral device interface 1023. The display 1050 may display status information, input characters, moving pictures, still images, or the like. For example, the display 1050 may display application program information driven by the processor 1022.

The input device 1060 may provide the processor unit 1020 with input data generated due to the selection of the terminal through the input/output controller 1040. Here, the input device 1060 may include a keypad including at least one hardware button, a touch pad sensing touch information, or the like. For example, the input device 1060 may provide the processor 1022 with touch information such as touch, touch movement, touch release, or the like, sensed through the touch pad, via the input/output controller 1040. In addition, the electronic terminal device 1000 may include the communications processor 1090 performing the communications function for voice communications and/or data communications.

While the inventive concept has been particularly shown and described with reference to illustrative embodiments thereof, it will be understood by those of ordinary skill in the pertinent art that various changes in form and details may be made therein without departing from the spirit and scope of the present disclosure as bounded by the following claims.

What is claimed is:

1. A method of determining a narrow beam, the method comprising:
sweeping a plurality of wide beams;
calculating a plurality of wide beam measurement results respectively corresponding to the plurality of wide beams;
calculating a reliability of the plurality of wide beam measurement results; and
when the reliability of the plurality of wide beam measurement results is greater than a first threshold value, determining at least one narrow beam based on the plurality of wide beam measurement results without sweeping the at least one narrow beam.

2. The method of claim 1, further comprising:
storing an index of the at least one narrow beam and a cell identification (ID) corresponding to the at least one narrow beam.

3. The method of claim 1, further comprising:
when the reliability of the plurality of wide beam measurement results is less than or equal to the first threshold value, sweeping the plurality of wide beams and updating the plurality of wide beam measurement results;
calculating reliability of the updated plurality of wide beam measurement results; and
when the reliability of the updated plurality of wide beam measurement results is greater than a second threshold value, determining at least one narrow beam based on the updated plurality of wide beam measurement results by using an artificial intelligence (AI) algorithm.

4. The method of claim 3, wherein the reliability of the plurality of wide beam measurement results is related to a variation within the plurality of wide beam measurement results.

5. The method of claim 1, further comprising selecting a narrow beam from among the at least one narrow beam, accessing a cell corresponding to the selected narrow beam by using the selected narrow beam, and performing physical broadcast channel (PBCH) decoding.

6. The method of claim 2, further comprising, when a handover event occurs, determining an index of a narrow beam based on a cell ID of a handover target cell, and performing a handover with the handover target cell by using the narrow beam corresponding to the determined index.

7. The method of claim 4, further comprising:
when the reliability of the updated plurality of wide beam measurement results is less than or equal to the second threshold value, selecting a wide beam based on the updated plurality of wide beam measurement results;
calculating a plurality of narrow beam measurement results corresponding to a plurality of narrow beams included in the selected wide beam; and
selecting a narrow beam based on the plurality of narrow beam measurement results.

8. The method of claim 4, wherein the sweeping of the plurality of wide beams and the updating of the plurality of wide beam measurement results comprise, after a transition period has elapsed since the plurality of wide beam measurement results have been obtained or an automatic gain control (AGC) is stabilized, sweeping the plurality of wide beams, and updating the plurality of wide beam measurement results by calculating the plurality of wide beam measurement results with respect to the plurality of wide beams.

9. The method of claim 2,
wherein the determining of the at least one narrow beam based on the plurality of wide beam measurement results comprises determining the at least one narrow beam and reliability corresponding to each of the at least one narrow beam based on the plurality of wide beam measurement results by using an artificial intelligence (AI) algorithm, and
wherein the storing of the index of the at least one narrow beam and the cell ID corresponding to the at least one narrow beam comprises storing an index of a narrow beam, from among the at least one narrow beam, having a reliability that is greater than a third threshold value, and storing a cell ID corresponding to the narrow beam.

10. The method of claim 9, further comprising:
when the reliability corresponding to each of the at least one narrow beam is less than or equal to the third threshold value, sweeping the plurality of wide beams and updating the plurality of wide beam measurement results; and
determining the at least one narrow beam based on the updated plurality of wide beam measurement results by using the AI algorithm.

11. The method of claim 1, wherein the plurality of wide beam measurement results include at least one of Reference Signal Received Power (RSRP), Reference Signal Received Quality (RSRQ), Received Signal Strength Indicator (RSSI), and Signal-to-Interference-plus-Noise Ratio (SINR) with respect to the plurality of wide beams.

12. The method of claim 1,
wherein determining the at least one narrow beam based on the plurality of wide beam measurement results is performed using an artificial intelligence (AI) algorithm that comprises at least one of a multilayer perceptron (MLP), a convolutional neural network (CNN), a recurrent neural network (RNN), a transformer, or a long short-term memory (LSTM).

13. A terminal comprising:
a radio frequency (RF) circuit configured to sweep a plurality of wide beams;
a processor configured to calculate a plurality of wide beam measurement results respectively corresponding to the plurality of wide beams, calculate a reliability of the plurality of wide beam measurement results; and
a narrow beam module configured to determine at least one narrow beam based on the plurality of wide beam measurement results without sweeping the at least one narrow beam, when the reliability of the plurality of wide beam measurement results is greater than a first threshold value.

14. The terminal of claim 13, further comprising:
a memory,
wherein the memory stores an index of the at least one narrow beam and a cell identification (ID) corresponding to the at least one narrow beam.

15. The terminal of claim 13,
wherein the processor is further configured to, when the reliability of the plurality of wide beam measurement results is less than or equal to the first threshold value, control the RF circuit to sweep the plurality of wide beams, update the plurality of wide beam measurement results, calculate the reliability of the updated plurality of wide beam measurement results, and when the reliability of the updated plurality of wide beam measurement results is greater than a second threshold value, determine the at least one narrow beam based on the updated plurality of wide beam measurement results by using the narrow beam module,
wherein the narrow beam module comprises an artificial intelligence (AI) module.

16. The terminal of claim 15, wherein the reliability of the plurality of wide beam measurement results is related to a variation within the plurality of wide beam measurement results.

17. The terminal of claim 13, wherein the processor is further configured to select a narrow beam from among the at least one narrow beam, access a cell corresponding to the selected narrow beam by using the selected narrow beam, and perform physical broadcast channel (PBCH) decoding.

18. The terminal of claim 14, wherein the processor is further configured to, when a handover event occurs, determine an index of a narrow beam stored in the memory based on a cell ID of a handover target cell, and perform the handover with the handover target cell by using the narrow beam corresponding to the determined index.

19. The terminal of claim 13, wherein the processor is further configured to, when the reliability of the plurality of wide beam measurement results is less than or equal to the first threshold value, after a transition period has elapsed since the plurality of wide beams measurement results have been obtained or an automatic gain control (AGC) is stabilized, control the RF circuit to sweep the plurality of wide beams, and update the plurality of wide beam measurement results by calculating the plurality of wide beam measurement results with respect to the plurality of wide beams.

20. An electronic device comprising:
a radio frequency (RF) circuit configured to sweep a plurality of wide beams; and
a processor configured to calculate a plurality of wide beam measurement results respectively corresponding to the plurality of wide beams, determine at least one narrow beam and a reliability corresponding to each of the at least one narrow beam based on the plurality of wide beam measurement results without sweeping the at least one narrow beam, and when the reliability corresponding to each of the at least one narrow beam is less than or equal to a threshold value, update the plurality of wide beam measurement results.
